(19) United States
(12) Patent Application Publication
(10) Pub. No.: US 2011/0281763 A1
(43) Pub. Date: Nov. 17, 2011

(54) Apparatus and methods for high-throughput analysis

(75) Inventors: Xiaoping Zhou, Changsha (CN); Jiangping Yi, Huzhou (CN); Jeff Qiang Xu, Sugar Land, TX (US)

(73) Assignee: Microvast, Inc., Stafford, TX (US)

(21) Appl. No.: 13/138,027

(22) PCT Filed: Dec. 23, 2009
(86) PCT No.: PCT/US09/69511

§ 371 Date: Jun. 23, 2011

Related U.S. Application Data
(60) Provisional application No. 61/140,415, filed on Dec. 23, 2008.

(51) Int. Cl. C40B 30/08; C40B 60/12

(52) U.S. Cl. 506/11; 506/39

(57) ABSTRACT

Disclosed is a high-throughput analysis apparatus. The high-throughput analysis apparatus comprises a sample introduction unit, a flow control unit, a separation unit, a detection unit, a signal collecting unit and a signal processing unit. Several methods using the same are also provided.

### CROSS-REFERENCE TO RELATED APPLICATIONS

This application claims priority to U.S. Provisional Application No. 61/140,415, filed Dec. 23, 2008, the disclosures of which are incorporated herein in their entirety.

### FEDERALLY SPONSORED RESEARCH

Not applicable.

### REFERENCE TO MICROFICHE APPENDIX

Not applicable.

### FIELD OF THE INVENTION

The present invention relates to apparatus and methods for high-throughput analysis.

### BACKGROUND OF THE INVENTION

As an important part of chemistry, synthetic chemistry is the foundation of modern chemical industry. Although considerable progress has been made in theoretical chemistry and chemical engineering, trial and error method, which generally spends much time and effort, is by far still being used widely for screening pharmaceuticals, agrochemicals, catalysts and some novel materials.

Combinatorial chemistry, emerged in the 1980s, made it feasible to synthesize thousands of samples with different compositions in a short time. Its application considerably shortens the products research period while various kinds of combinatorial techniques successively come forth. However, the existing problem is how to efficiently screen desired lead compound from large amounts of candidates. To solve this problem, various analytical methods, such as MS, chromatography, chromatography-MS, IR, NMR and UV-VIS etc, were chosen for sample testing in combinatorial chemistry. In general, these means were carried out serially which were yet inefficient, time-consuming processes.

To overcome the above-mentioned difficulties, some parallel analysis apparatus came into scene in recent years. By using these apparatus a good number of samples could be simultaneously analyzed in a very short time. But their exorbitant price and shortcoming in quantitative analysis hobble their applications. Therefore, more rapid, efficient and inexpensive multifunctional analyzing systems are required.

### SUMMARY OF THE INVENTION

The present invention provides a high-throughput analysis apparatus, which could realize high-throughput separation, qualitative and quantitative analysis of samples simultaneously, comprising: a sample introduction unit, a flow control unit, a separation unit, a detection unit, a signal collecting unit and a signal processing unit. The said flow control unit includes a flow splitter that could distribute one stream into a plurality of streams and the flow rate of each stream could be independently controlled.

In another aspect, the present invention provide several methods of conducting high-throughput analysis using the same apparatus, such as a method of conducting the high-throughput analysis for screening catalysts, a method of conducting the high-throughput analysis for measuring the surface area of catalysts, a method of conducting the high-throughput analysis for inter-channels parallel measurement, a method of conducting the high-throughput analysis for compounds separation and measurement of the contents of a plurality of samples, etc.

It could be seen from the following detailed description of this invention that the high-throughput analysis apparatus could conduct simultaneous high-throughput separation, qualitative and quantitative analysis of many samples in a short time, and it would be a great progress in combinatorial chemistry.

### BRIEF DESCRIPTION OF THE DRAWINGS

FIG. 1 illustrates a structure cartoon picture of the present invention.

FIG. 2 illustrates another embodiment of the present invention.

FIG. 3 illustrates another embodiment of the present invention.

FIG. 4 illustrates another embodiment of the present invention.

FIG. 5 is a reaction plate of an embodiment of the present invention.

FIG. 6 is a partial view of the reaction plate of an embodiment of the present invention.

FIG. 7 is the enlarged view of A area in FIG. 6.

FIG. 8 is a reaction plate of another embodiment of the present invention.

FIG. 9 is the enlarged view of B area in FIG. 8.

FIG. 10 is a cross sectional view of the separation box in an embodiment of the present invention.

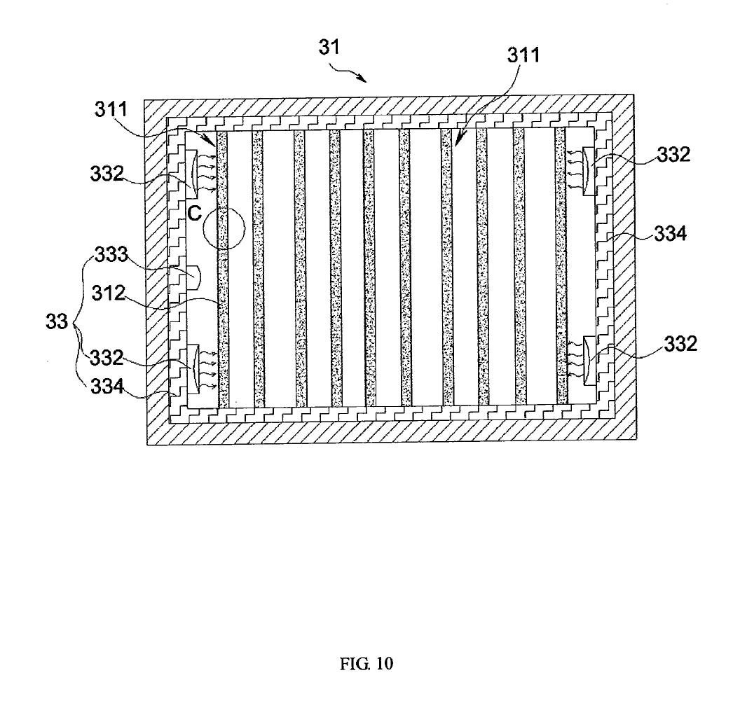

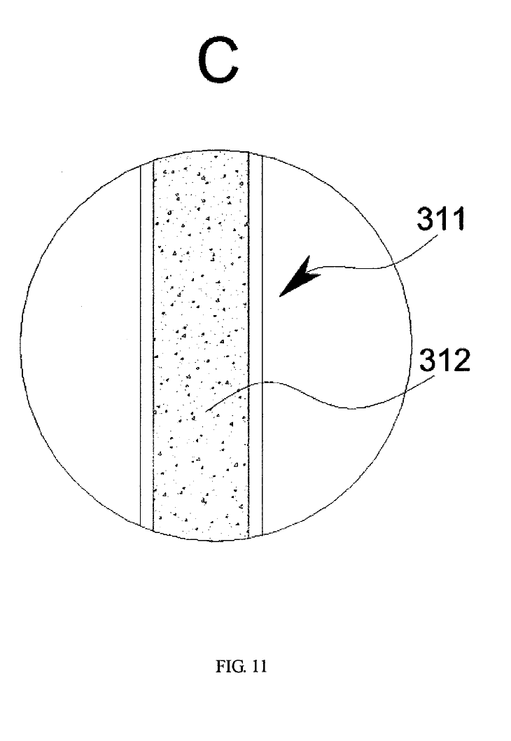

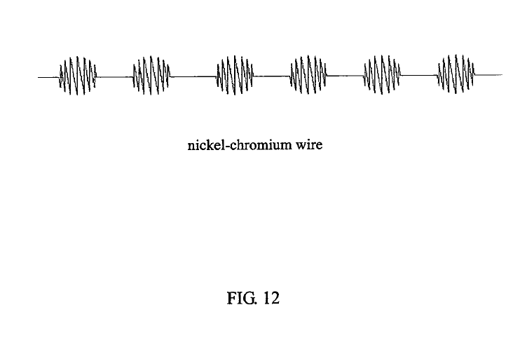

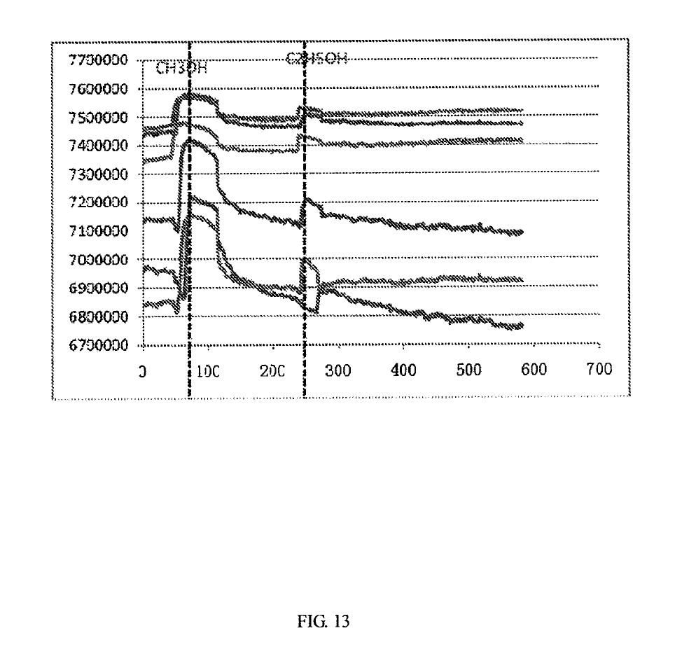

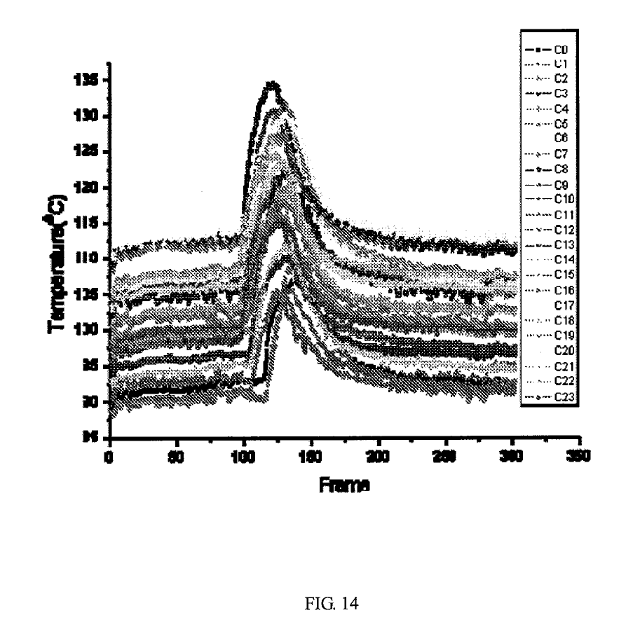

FIG. 11 is the enlarged view of C area in FIG. 10.
In which, 1. sample introduction unit; 2. flow control unit; 3. separation unit; 4. detection unit; 5. signal collecting unit; 6. signal processing unit; 111. carrier gas bottle; 12. multichannel valve; 13. bubbler; 14. sampler; 21. mass flow controller; 22. flow splitter; 31. separation box; 33. temperature control device; 41. reaction plate; 311. separation column; 312. filler; 332. fan blower; 333. temperature sensor; 334. heating resistance wire; 411. well; 412. hole for heating rod; 413. heating rod; 414. porous disk; 415. catalyst; 4111. hole; 4112. resistance wire.

FIG. 12 is the resistance wire in series in the Example 1 and Example 2.

FIG. 13 is the result of separating the mixture of methanol and ethanol in Example 1.

FIG. 14 is the retention time of methanol in Example 2.

### DETAILED DESCRIPTION OF THE INVENTION

The object of the present invention is to provide a high-throughput analysis apparatus which is structurally simple and able to carry out separation, qualitative and quantitative analysis of many samples simultaneously, and also the methods of conducting the same.

According to one aspect of the present invention, the high-throughput analysis apparatus in the present invention comprises: at least one sample introduction unit; a flow control unit; a separation unit; a detection unit; a signal collecting unit and a signal processing unit. The said detection unit is connected to the separation unit; the said signal processing unit is connected to the signal collecting unit; and the said separation unit is connected, directly or by a flow controller, to the sample introduction unit.

According to another aspect of the present invention, the flow control unit includes at least one flow splitter, which could distribute one stream into a lot of streams and the flow rate of each stream could be independently controlled (as described in the application of CN 2005100325486).

According to another aspect of the present invention, the sample introduction unit comprises one or more multichannel valves and one or more bubblers; the flow control unit includes at least one mass flow controller; the separation unit comprises a separation box and a plurality of separation columns fixed in the box; the multichannel valve is connected in parallel with the bubbler; the mass flow controller, the parallel connection device of multichannel and bubbler, the flow splitter, and the separation box are connected in order; the outlets of the flow splitter are connected to the inlets of the separation columns.

According to another aspect of the present invention, the sample introduction unit includes a plurality of bubblers; the flow control unit includes a mass flow controller; the separation unit comprises a separation box and a plurality of separation columns fixed in the box; the flow splitter is connected to the mass flow controller; the outlets of the flow splitter are connected to the inlets of the bubblers, and the outlets of the bubblers are connected to the inlets of the separation columns.

According to another aspect of the present invention, the sample introduction unit includes a plurality of sampling devices, which could be sample syringes, automatic samplers or channels connected to other parallel reactors; the flow control unit includes a mass flow controller; the separation unit comprises a separation box and a plurality of separation columns fixed in the box; the flow splitter is connected to the mass flow controller, the outlets of the flow splitter are connected to the inlets of the separation columns, and the outlets of the sampling devices are connected to the inlets of the separation columns.

According to another aspect of the present invention, the configuration (means the length, diameter, geometry and etc.) of the separation columns can vary with the volume of separation box and the quantity of itself.

According to another aspect of the present invention, the separation columns are filled with fillers.

The said fillers could be adsorption materials (such as active carbon), other chromatography materials, or samples to be determined.

According to another aspect of the present invention, the separation unit further includes a temperature controlling device.

The said temperature controlling device comprises a plurality of heating resistance wires, at least one fan blower, at least one temperature sensor and at least one temperature controller connected to the temperature sensor.

According to another aspect of the present invention, the detection unit includes a reaction plate, in which there are arrayed wells, and catalysts could be placed in these wells. There is at least one through hole in the bottom of each well, which penetrates the reaction plate. In each well, there is a porous disk for carrying catalysts. The said reaction plate further includes at least one hole for placing heating rod.

According to another aspect of the present invention, the detection unit includes a reaction plate, in which there is arrayed wells. There is at least one through hole in the bottom of each well, which penetrates the reaction plate. The resistance wires for heating could be placed in the wells. The catalysts could be coated on the resistance wires or put into the wells to contact with the said resistance wires.

According to another aspect of the present invention, the signal collecting unit is an infrared imaging apparatus.

According to another aspect of the present invention, the signal collecting unit is an array consisted of thermal sensitive materials. The temperature difference among the different wells could be identified by thermal sensitive materials and further transformed into electric signal to complete the signal collecting. When the thermal sensitive materials are used in the signal collecting unit and heating rods are used for heating, the catalysts could be coated on the thermal sensitive material, or placed on the porous disks in the wells. When resistance wires are used for heating, the catalysts could be coated on the resistance wires or on the thermal sensitive material, preferably on the resistance wires.

According to another aspect of the present invention, the porous disk is made of carbon fiber paper.

According to another aspect of the present invention, the porous disk is made of glass fiber paper.

According to another aspect of the present invention, a method of conducting the high-throughput analysis apparatus for screening of catalysts is provided, comprising:
a) putting catalysts to be determined in different wells of a reaction plate;
b) introducing carrier gas into a bubbler through a mass flow controller, and then carrying out the sample in the bubbler;
c) directing the mixture of carrier gas and sample into a flow splitter, wherein the mixture flow is evenly distributed into N streams (N is a positive integer), directing each stream into a corresponding separation column in the separation box and then heating the columns under the same condition;
d) reacting the samples desorbed out of separation columns on the catalysts, collecting the reaction times and reaction intensities by a signal collecting unit and then transmitting these data to a signal processing unit;
e) analyzing the data, and the catalysts showing good performance can be screened out.

According to another aspect of the present invention, a method of conducting the high-throughput analysis apparatus for measuring the surface areas of catalysts is provided, comprising:
a) putting the same catalyst in different wells of a reaction plate;
b) filling at least one separation column with a kind of material whose surface area is known;
c) filling the other columns with materials to be determined;
d) introducing carrier gas into a bubbler through a mass flow controller, and then carrying out the substance in the bubbler;
e) directing the mixture of carrier gas and the substance into a flow splitter, wherein the mixture flow is evenly distributed into N streams (N is a positive integer), directing each stream into a corresponding separation column in the separation box and then heating the columns under the same condition;
f) reacting the substance desorbed out of separation columns on the catalyst, collecting the reaction times and reaction intensities by a signal collecting unit and then transmitting these data to a signal processing unit;
g) comparing the peak area of the substance out from the column filled with samples with that of the substance out from the column filled with the material whose surface area is known, and calculating the surface areas of the samples.

According to another aspect of the present invention, a method of conducting the high-throughput analysis apparatus for inter-channel parallel measurement is provided, comprising:
a) putting the same catalyst in different wells of a reaction plate;
b) introducing carrier gas into a bubbler through a mass flow controller, and then carrying out the known substance in the bubbler;
c) directing the mixture of carrier gas and substance into a flow splitter, wherein the mixture flow is evenly distributed into N streams (N is a positive integer), directing each stream into a corresponding separation column in the separation box and then heating the columns under the same condition;
d) reacting the substance desorbed out of separation columns on the catalyst, collecting the retention times, reaction times and reaction intensities by a signal collecting unit then transmitting these data to a signal processing unit;
e) comparing the retention times, reaction times and reaction intensities of the channels and getting the inter-channel parallel result.

According to another aspect of the present invention, a method of conducting the high-throughput analysis apparatus for component separation and content measurement of a plurality of samples is provided, comprising:
a) putting the same catalyst in different wells of a reaction plate;
b) filling all columns with the same adsorption material;
c) introducing carrier gas into a flow splitter through a mass flow controller, wherein the carrier gas flow is evenly distributed into N streams (N is a positive integer), directing each stream into a corresponding separation column in the separation box through a bubbler, wherein the bubblers contain different samples, and then heating the columns under the same condition;
d) reacting the components desorbed out of separation columns on the catalyst, collecting the retention times, reaction times and reaction intensities by a signal collecting unit then transmitting these data to a signal processing unit;
e) analyzing the data to get the components and contents of the samples.

According to another aspect of the present invention, a method of conducting the high-throughput analysis apparatus for component separation and content measurement of a plurality of samples is provided, comprising:
a) coating the same catalyst on the resistance wire in different wells of a reaction plate;
b) filling all columns with the same adsorption material;
c) introducing carrier gas into a flow splitter through a mass flow controller, wherein the carrier gas flow is evenly distributed into N streams (N is a positive integer), directing each stream into a corresponding separation column in the separation box through a bubbler, wherein the bubblers contain different samples, and then heating the columns under the same condition;
d) reacting the components desorbed out of separation columns on the catalyst, collecting the retention times, reaction times and reaction intensities by a signal collecting unit then transmitting these data to a signal processing unit;
e) analyzing the data to get the components and contents of the samples.

According to another aspect of the present invention, a method of conducting the high-throughput analysis apparatus for component separation and content measurement of a plurality of samples is provided, comprising:
a) putting different samples in different samplers;
b) putting the same catalyst in different wells of a reaction plate;
c) filling all columns with the same adsorption material;
d) introducing carrier gas into a flow splitter through a mass flow controller, wherein the carrier gas flow is evenly distributed into N streams (N is a positive integer), then directing each stream into a corresponding separation column in the separation box;
e) simultaneously injecting the samples in different samplers into the corresponding separation columns, and then heating the columns under the same condition;
f) reacting the components desorbed out of separation columns on the catalyst, collecting the retention times, reaction times and reaction intensities by a signal collecting unit then transmitting these data to a signal processing unit;
g) analyzing the data to get the components and contents of the samples.

According to another aspect of the present invention, a method of conducting the high-throughput analysis apparatus for component separation and content measurement of a plurality of samples is provided, comprising:
a) putting different samples in different samplers;
b) coating the same catalyst on the resistance wires in different wells of a reaction plate;
c) filling all columns with the same adsorption material;
d) introducing carrier gas into a flow splitter through a mass flow controller, wherein the carrier gas flow is evenly distributed into N streams (N is a positive integer), then directing each stream into a corresponding separation column in the separation box;
e) simultaneously injecting the samples in different samplers into the corresponding separation columns, and then heating the columns under the same condition;
f) reacting the components desorbed out of separation columns on the catalyst, collecting the retention times, reaction times and reaction intensities by a signal collecting unit then transmitting these data to a signal processing unit;
g) analyzing the data to get the components and contents of the samples.

In which, the said retention time is the time elapsed between the injection point and the peak maximum; the said reaction time is the time elapsed between the signal emerging and the signal disappearing, manifested as peak width; the said reaction intensity is the intensity of the peak detected by the signal detection unit, manifested as peak height.

The present invention has the following features:
1) simple structure and low cost;
2) catalyst screening could be conducted conveniently and quickly;
3) the surface area of materials could be measured by the system;
4) the components and contents of a plurality of samples could be separated and high-throughput qualitatively and quantitatively measured.

### EXAMPLES

The following description illustrates embodiments of the present invention by way of example and not by way of limitation. Thus, the embodiments described below just represent preferred embodiments of the present invention.

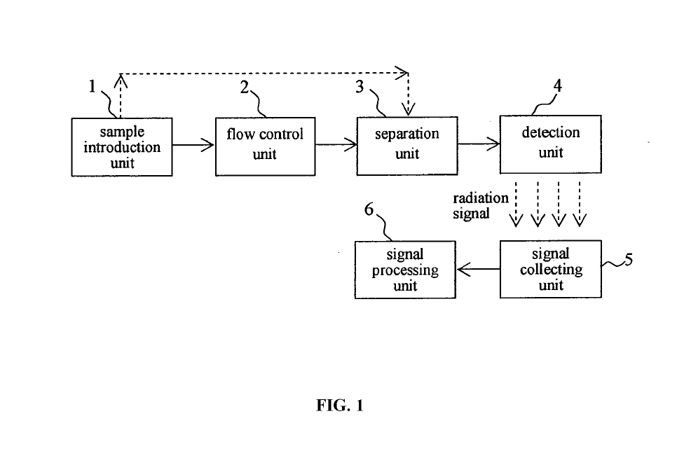

The present invention provides a high-throughput analysis apparatus as shown in FIG. 1, comprising:
sample introduction unit 1;
flow control unit 2;
separation unit 3;
detection unit 4, the said detection unit 4 is connected to the separation unit 3;
signal collecting unit 5;
signal processing unit 6, the said signal processing unit 6 is electrically connected to the signal collecting unit 5;
the said separation unit 3 could be connected to the sample introduction unit 1 by the flow control unit 2;
alternatively, the said separation unit 3 could be directly connected to the sample introduction unit 1;
the said flow splitter 22 could distribute one stream into a plurality of streams and the flow rate of each stream could be independently controlled.

### Example 1

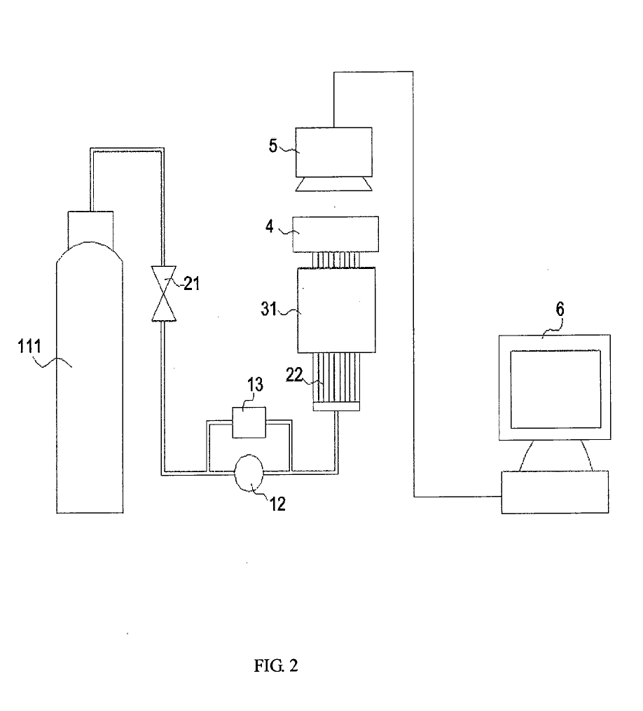

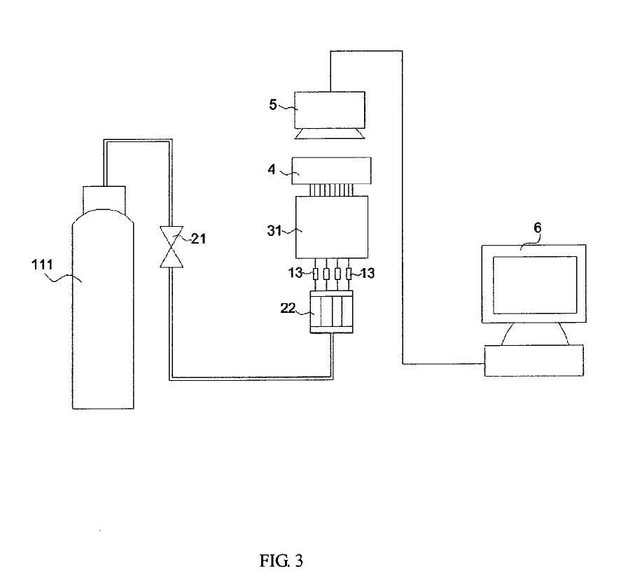

The system was illustrated as shown in FIG. 2: The sample introduction unit 1 comprised a six-port valve 12 and a bubbler 13.

The flow control unit 2 comprised a mass flow controller 21 and a flow splitter 22, and the mass flow controller 21 connects the six-port valve 12 with carrier gas bottle 111.

The separation unit 3 comprised a separation box 31 and 8×8 separation columns 311 in the box. The flow splitter 22 connected the six-port valve 12 with the separation box 31, which could distribute one stream into many streams and each stream could be independently controlled, and these streams were directed into the separation columns 311.

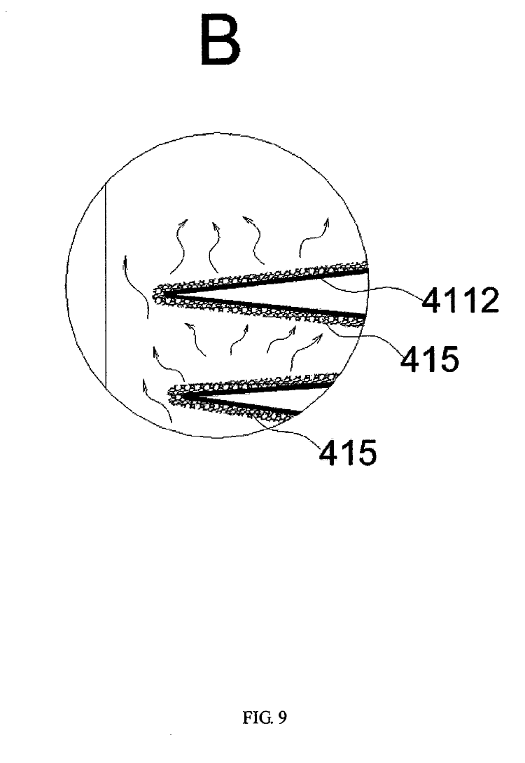

The separation columns 311 were linear columns, as shown in FIG. 9 and FIG. 10. The columns (external diameter 3 mm, internal diameter 2 mm, and length 48 mm) were stainless steel and the filler was high molecule polymer beads of GDX-02 (bought from SHENYANG 5^{th} Reagent Factory, 60˜80 mesh).

Temperature control device 33 was fixed in separation box 31. The said temperature control device 33 comprised four heating resistance wires 334, a fan blower 332, a temperature sensor 333 and a temperature controller. The heating resistance wires 334 were used for heating and the fan blower 332 for keeping temperature uniformity in the separation box 31.

The said detection unit 4 included a reaction plate 41 and the reaction plate was made of synthetic stone plate. The reaction plate comprised a bottom plate and an upper plate of reaction cell and a rubber seal ring was used between them for sealing. There were 8×8 wells 411 in the reaction plate 41, and 8×8 through holes 4111 which penetrates the reaction plate 41 in the bottom of the wells 411. The resistance wires 4112, made of nickel-chromium wire, were fixed in the wells 411, as illustrated in FIG. 12. Each nickel-chromium wire was made into a series resistance wire with 8 zigzag resistance wire units as the shape showed in FIG. 12. The resistance of each series resistance wire was 17.5 ohm. Eight such series resistance wire were made and placed in the corresponding wells in parallel. There were catalysts in the wells 411, covering the resistance wires 4112.

The said catalyst was 30% PtRu/ZrO₂ (mole ratio: Pt:Ru=1:1), prepared as following: H₂PtCl₆.6H₂O (0.531 g) and RuCl₃.3H₂O (0.2684 g) were added into a beaker (1000 mL), then 1-Dodecanethiol (3.6 mL) and Benzene (200 mL) were added and stirred. The beaker was put in a water bath at 55° C. and Tert-butylamine Borane (1.7830 g) was added and stirred for 1 h. Then C₂H₅OH (200 mL) was added and cooled to room temperature, dried at 55° C. for 20 h. The prepared black powder was dissolved in 600 mL ether, ZrO₂ (1 g) was added and stirred until ether was volatile completely. The resulted black powder was calcined at 300° C. for 1 h to provide catalyst 30% PtRu/ZrO₂. The catalyst 30% PtRu/ZrO₂ (2.6 g) was prepared.

In this embodiment of the present invention, the said signal collecting unit 5 was an infrared imaging apparatus, the signal processing unit 6 was a data processing software developed in house.

The apparatus of the present invention could be use for inter-channel parallel measurement. The said inter-channel parallel measurement means that the difference range among the results of different channels under the same condition using the same sample is conducted. The operation steps are listed as follow:
a) filling 40 mg catalyst 30% PtRu/ZrO₂ in every well of a row 6 wells 411 in the reaction plate 41;
b) adding the sample (the mixture of methanol and ethanol) in the bubbler;
c) introducing carrier gas into the bubbler 13 through the mass flow controller 21 and the six-port valve, carrying out the sample in the bubbler 13;
d) introducing the mixture of carrier gas and sample into the flow splitter 22, wherein the mixture was distributed into 8×8 streams, directing each stream into a corresponding separation column 311 in the separation box 31;
e) controlling the temperature of the separation box and keeping all columns at the same temperature;
f) reacting the sample desorbed out of separation columns 311 on the catalyst, collecting the retention times, reaction times and reaction intensities of different channels by the signal collecting unit 5 and then transmitting these data to the signal processing unit 6;
g) transforming the reaction intensities into the integrated intensities or temperature of the channels by the signal processing unit 6;
h) comparing the retention times and integrated intensities of the channels to get the interchannel parallelism result.

The retention times graph of the mixture sample of methanol and ethanol is given in FIG. 13, some testing conditions as follow: methanol (7 mL) and ethanol (7 mL) were added into the bubbler at room temperature; the flow rate of carrier gas was 10 mL/min for every channels; starting programmed temperature after 6 min of bubbling; keeping the temperature at 30° C. for 5 min, rising to 35° C. in 10 min, rising to 40° C. in 5 min, rising to 50° C. in 5 min and keeping for 10 min, rising to 60° C. in 5 min and keeping for 20 min, finally cooled to room temperature. The graph of FIG. 13 was given through the processing by data processing software developed in house.

### Example 2

The sample introduction unit 1 comprised a sampler 14 and a bubbler 13 as illustrated in FIG. 4.

The flow control unit 2 comprised a mass flow controller 21 and a flow splitter 22, and the mass flow controller 21 was connected to the flow splitter 22, the outlets of the flow splitter 22 were connected to the inlets of a plurality of separation columns 311. The outlets of 8×8 samplers 14 were connected to the inlets of 8×8 separation columns 311. The flow splitter 22 could distribute one stream into many streams and each stream could be independently controlled, and these streams were directed into the separation columns 311.

The separation columns 311 were linear columns, as shown in FIG. 9 and FIG. 10. The columns (external diameter 3 mm, internal diameter 2 mm, and length 48 mm) were stainless steel and the filler was high molecule polymer bead of GDX-02 (bought from SHENYANG 5^{th} Reagent Factory, 60˜80 mesh).

Temperature control device 33 was fixed in separation box 31. The said temperature control device 33 comprised four heating resistance wires 334, a fan blower 332, a temperature sensor 333 and a temperature controller. The heating resistance wires 334 were used for heating and the fan blower 332 for keeping temperature uniformity in the separation box 31.

The detection unit 4 included a reaction plate 41 and the reaction plate was made of synthetic stone plate. The reaction plate comprised a bottom plate and an upper plate of reaction cell and a rubber seal ring was used between them for sealing. There were 8×8 wells 411 in the reaction plate 41, and there was a through holes 4111 which drills through the reaction plate 41 in the bottom of the wells 411. The resistance wires 4112 made of nickel-chromium wire were placed in the wells 411, as illustrated in FIG. 12. Each nickel-chromium wire was made into a series resistance wire with 8 zigzag resistance wire units as the shape showed in FIG. 12. The resistance of each series resistance wire was 17.5 ohm. Eight such series resistance wires were made and placed in the corresponding wells in parallel. There were catalysts in the wells 411, covering the resistance wires 4112.

The catalyst was 30% PtRu/ZrO₂ (mole ratio: Pt:Ru=1:1), prepared as following: H₂PtCl₆.6H₂O (0.531 g) and RuCl₃.3H₂O (0.2684 g) were added into a beaker (1000 mL), then 1-Dodecanethiol (3.6 mL) and Benzene (200 mL) were added and stirred. The beaker was put in a water bath at 55° C. and Tert-butylamine Borane (1.7830 g) was added and stirred for 1 h. Then C₂H₅OH (200 mL) was added and cooled to room temperature, dried at 55° C. for 20 h. The prepared black powder was dissolved in 600 mL ether, ZrO₂ (1 g) was added and stirred until ether was volatile completely. The resulted black powder was calcined at 300° C. for 1 h to provide catalyst 30% PtRu/ZrO₂. The catalyst 30% PtRu/ZrO₂ (2.6 g) was prepared.

In this embodiment of the present invention, the said signal collecting unit 5 was an infrared imaging apparatus, the signal processing unit 6 was a commercial data processing software IR Guide Analyzer (WUHAN GAODE).

The apparatus of the present invention could be used for inter-channel parallel measurement. The said inter-channel parallel means that the difference range among the results of different channels under the same condition using the same sample is conducted. The operation steps are listed as follow:
a) filling 40 mg catalyst 30% PtRu/ZrO₂ in every well of 4×6 wells 411 in the reaction plate 41;
b) adding the sample (methanol) in the bubbler;
c) introducing carrier gas into the bubbler 13 through the mass flow controller 21 and six-port valve, carrying out the sample in the bubbler 13;
d) introducing the mixture of carrier gas and sample into the flow splitter 22, wherein the mixture was distributed into 8×8 streams, directing every stream into a corresponding separation column 311 in the separation box 31;
e) controlling the temperature of separation box and keeping all columns at the same temperature;
f) reacting the sample desorbed out of separation columns 311 on the catalyst, collecting the retention times, reaction times and reaction intensities of different channels by the signal collecting unit 5 and then transmitting these data to the signal processing unit 6;
g) transforming the reaction intensities into the integrated intensities or temperature of the channels by the signal processing unit 6;
h) comparing the retention times and integrated intensities of the channels to get the interchannel parallelism result.

The retention times graph of the sample methanol is given in FIG. 14, some testing conditions as follow: methanol (100 μL, equal to 1.56 μL for every channel) was injected into the bubbler; the bubbler was put into a water bath at 70° C. (higher than the boiling point of methanol), the flow rate of carrier gas was 10 mL/min for every channels; the temperature of the separation box was kept at 45° C. The graph of FIG. 13 was given through the processing by ER Guide Analyzer.

### Example 3

The system is illustrated as shown in FIG. 2: The sample introduction unit 1 comprised a six-port valve 12 and a bubbler 13.

The flow control unit 2 comprised a mass flow controller 21 and a flow splitter 22, and the mass flow controller 21 connected the six-port valve 12 with carrier gas bottle 111.

The separation unit 3 comprised a separation box 31 and 8×8 separation columns 311 in the box. The flow splitter 22 connected the six-port valve 12 with the separation box 31, which could distribute one stream into many streams and each stream could be independently controlled, and these streams were directed into the separation columns 311.

The separation columns 311 were straight columns, as shown in FIG. 10 and FIG. 11. The columns were filled with active carbon (surface area 1564 m²/g).

Temperature control device 33 was fixed in the separation box 31. The said temperature control device 33 comprised four heating resistance wires 334, a fan blower 332, a temperature sensor 333 and a temperature controller. The heating resistance wires 334 were used for heating and the fan blower 332 for keeping temperature uniformity in the separation box 31.

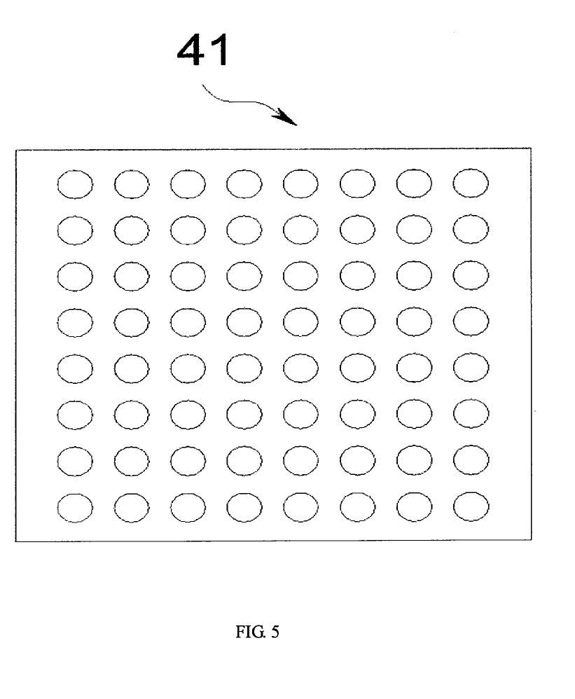

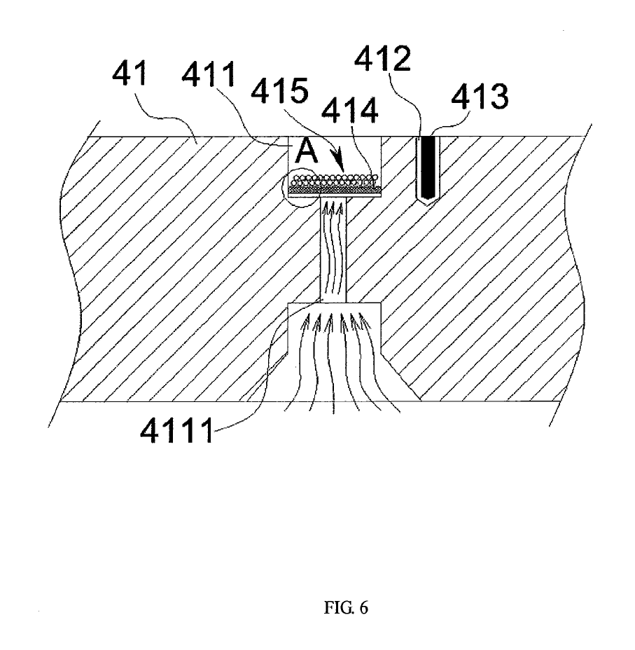

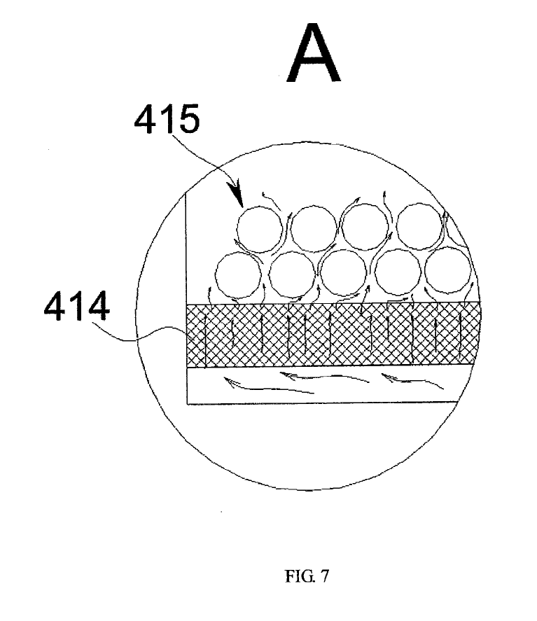

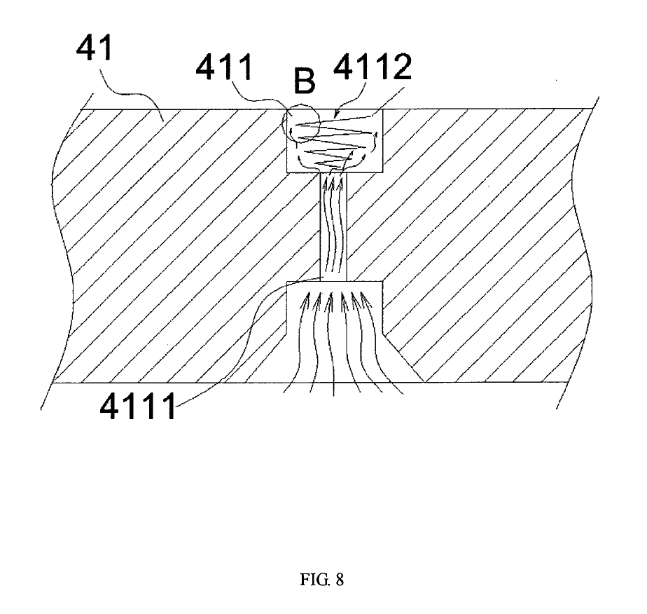

The detection unit 4 included a reaction plate 41 and the partial schematic diagram is provided in FIG. 5 and FIG. 6: There were 8×8 wells 411 in the reaction plate 41, and there was a through hole 4111 which penetrates the reaction plate 41 in the bottom of the wells 411. The bottom ends of the through holes 4111 were cone-shaped similar opens and were connected to the separation columns 311 for separating the samples from the separation columns 311. There were porous disks 414 in the wells 411, and the catalyst beds 415 were put on the porous disks 414. There were also 8×8 holes for heating rods 412 in the reaction plate 41, the heating rods 413 were put in the holes of heating rods 412 to heat the catalyst beds 415.

In this embodiment of the present invention, the porous disks 414 were made of carbon fiber paper.

In this embodiment of the present invention, the signal collecting unit 5 was an infrared imaging apparatus, the signal processing unit 6 was a data processing software developed in house.

The apparatus in this embodiment was capable of screening catalysts, as follow:
a) putting the catalysts to be determined in the wells 411 of the reaction plate 41;
b) introducing carrier gas into the bubbler 13 through the mass flow controller 21, carrying out the sample in the bubbler 13;
c) introducing the mixture of carrier gas and sample into the flow splitter 22, wherein the mixture was distributed into 8×8 streams, directing each stream into a corresponding separation column 311 in the separation box 31 and heating them at the same temperature;
d) reacting the sample desorbed out of separation columns 311 on the catalyst, collecting the starting reaction times and reaction intensities of different channels by the signal collecting unit 5 and then transmitting these data to the signal processing unit 6;
e) analyzing the data, and the catalysts showing good performance can be screened out.

### Example 4

The system is illustrated as shown in FIG. 2: The sample introduction unit 1 comprises a six-port valve 12 and a bubbler 13.

The flow control unit 2 comprised a mass flow controller 21 and a flow splitter 22, and the mass flow controller 21 connected the six-port valve 12 with carrier gas bottle 111.

The separation unit 3 comprised a separation box 31 and 8×8 separation columns 311 in the box. The flow splitter 22 connected the six-port valve 12 with the separation box 31, which could distribute one stream into many streams and each stream could be independently controlled, and these stream were directed into the separation columns 311.

The separation columns 311 were linear columns, as shown in FIG. 9 and FIG. 10. The columns (external diameter 3 mm, internal diameter 2 mm, and length 48 mm) were stainless steel and the filler was high molecule polymer bead of GDX-02 (bought from SHENYANG 5^{th} Reagent Factory, 60˜80 mesh).

The temperature control device 33 was fixed in the separation box 31. The said temperature control device 33 comprised four heating resistance wires 334, a fan blower 332, a temperature sensor 333 and a temperature controller. The heating resistance wires 334 were used for heating and the fan blower 332 for keeping temperature uniformity in the separation box 31.

The detection unit 4 included a reaction plate 41 and the partial schematic diagram is provided in FIG. 5 and FIG. 6: There were 8×8 wells 411 in the reaction plate 41, and there was a through hole 4111 which penetrates the reaction plate 41 in the bottom of the wells 411. The bottom ends of the through holes 4111 were cone-shaped similar opens and were connected to the separation columns 311 for separating the samples from the separation columns 311. There were porous disks 414 in the wells 411, and the catalyst beds 415 were put on the porous disks 414. There were also 8×8 holes for heating rods 412 in the reaction plate 41, the heating rods 413 were put in the holes of heating rods 412 to heat the catalyst beds 415.

In this embodiment of the present invention, the porous disks 414 were made of carbon fiber paper.

In this embodiment of the present invention, the signal collecting unit 5 was an infrared imaging apparatus, the signal processing unit 6 was a commercial data processing software IR Guide Analyzer (WUHAN GAODE).

The apparatus in this example was capable of screening catalysts, as follow:
a) putting the same catalyst in the wells 411 in the reaction plate 41;
b) filling the separation columns 311 with a material whose surface area is known;
c) filling the other separation columns 311 with materials to be determined;
d) introducing carrier gas into the bubbler 13 through the mass flow controller 21, carrying out the substance in the bubbler 13;
e) introducing the mixture of carrier gas and substance into the flow splitter 22, wherein the mixture was distributed into N streams, directing each stream into a corresponding separation column 311 in the separation box 31 and heating them at the same temperature;
f) reacting the sample desorbed out of separation columns 311 on the catalyst, collecting the starting reaction times of different channels by the signal collecting unit 5 and then transmitting these data to the signal processing unit 6;
g) comparing the retention time of the substance out from the column filled with samples with that of the substance out from the column filled with the material whose surface area is known, and calculating the surface areas of the samples.

### Example 5

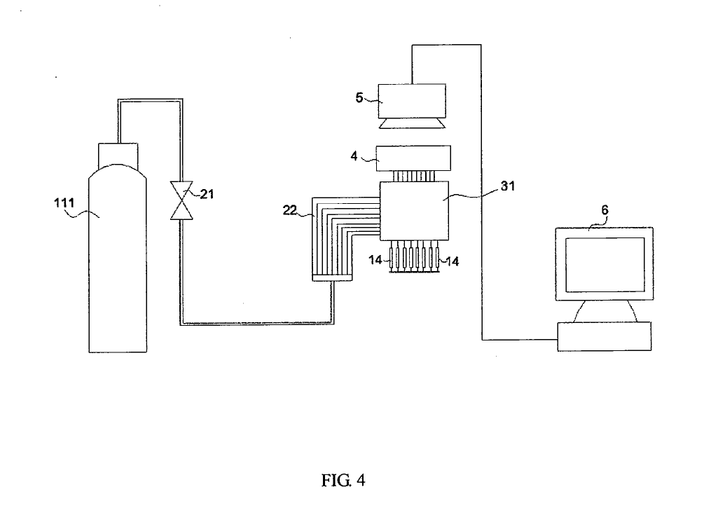

As is illustrated in FIG. 3, the sample introduction unit 1 comprised 8×8 bubblers 13.

The flow control unit 2 comprised a mass flow controller 21.

The separation unit 3 comprised a separation box 31 and 8×8 separation columns 311 in the separation box.

The mass flow controller 21 was connected to the flow splitter 22, the outlets of the flow splitter 22 were connected to the inlets of 8×8 bubblers 13 and the outlets of 8×8 bubblers 13 were connected to the inlets of the 8×8 separation columns 311.

The detection unit 4 included a reaction plate 41, there were 8×8 wells 411 for putting the catalysts 415 in the reaction plate 41, there were 8×8 through holes 4111 which penetrates the reaction plate 41 in the bottom of the wells 411. There were porous disks 414 in the wells 411 for supporting the catalyst 415. There were also 8×8 holes for heating rods 412 in the reaction plate 41, and the heating rods 413 were put in the holes of heating rods 412 to heat the catalyst 415.

The apparatus in this example was capable of identifying component and measuring content of a plurality of samples, as follow:
a) putting the same catalyst in the 8×8 wells 411 in the reaction plate 41;
b) filling the separation columns 311 with a adsorption material;
c) introducing the carrier gas into the flow splitter 22 through the mass flow controller 21, wherein the carrier gas was distributed into 8×8 streams, directing each stream into the corresponding separation column 311 through the bubbler 13, in which the samples are added, and heating the separation columns 311 at the same temperature;
d) reacting the samples desorbed out of separation columns 311 on the catalyst, collecting the retention times, reaction times and reaction intensities of different channels by the signal collecting unit 5 and then transmitting these data to the signal processing unit 6;
e) analyzing the data to identify the components and contents of the samples.

### Example 6

As is illustrated in FIG. 3, the sample introduction unit 1 comprised 8×8 bubblers 13.

The flow control unit 2 comprised a mass flow controller 21.

The separation unit 3 comprised a separation box 31 and 8×8 separation columns 311 in the box.

The mass flow controller 21 was connected to the flow splitter 22, the outlets of the flow splitter 22 were connected to the inlets of the bubblers 13 and the outlets of the bubblers 13 were connected to the inlets of the 8×8 separation column 311.

The detection unit 4 includes a reaction plate 41, there were 8×8 wells 411 in the reaction plate 41, there were 8×8 through holes 4111 which penetrates the reaction plate 41 in the bottom of the wells 411. There were resistance wires 4112 made of metal material in the wells 411 and the resistance wires 4112 were coated by catalyst. In test, the catalysts were heated by the resistance wires 4112 to start the reaction of the samples.

The apparatus in this example was capable of identifying component and measuring content of a plurality of samples, as follow:
a) coating the resistance wires 4112 of 8×8 wells 411 in the reaction plate 41 with the same catalyst;
b) filling the separation columns 311 with a adsorption material;
c) introducing the carrier gas into the flow splitter 22 through the mass flow controller 21, wherein the carrier gas was distributed into 8×8 streams, directing each stream into the corresponding separation column 311 through the bubbler 13, in which the samples are added, and heating the separation columns 311 at the same temperature;
d) reacting the samples desorbed out of separation columns 311 on the catalyst, collecting the retention times, reaction times and reaction intensities of different channels by the signal collecting unit 5 and then transmitting these data to the signal processing unit 6;
e) analyzing the data to identify the components and contents of the samples.

### Example 7

As is illustrated in FIG. 4, the sample introduction unit 1 comprised 8×8 samplers 14.

The flow control unit 2 comprised a mass flow controller 21.

The separation unit 3 comprised a separation box 31 and 8×8 separation columns 311 in the separation box.

The mass flow controller 21 was connected to the flow splitter 22, the outlets of the flow splitter 22 were connected to the inlets of 8×8 separation column 311 and the outlets of 8×8 samplers 14 were also connected to the inlets of 8×8 separation column 311.

The detection unit 4 included a reaction plate 41, there were 8×8 wells 411 for putting the catalysts 415 in the reaction plate 41, there were 8×8 through holes 4111 which penetrates the reaction plate 41 in the bottom of the wells 411. There were porous disks 414 in the wells 411 for supporting the catalyst 415. There were also 8×8 holes for heating rods 412 in the reaction plate 41, and the heating rods 413 were put in the holes of heating rods 412.

The apparatus in this example was capable of identifying component and measuring content of a plurality of samples, as follow:
a) adding samples to be determined in the samplers 14;
b) putting the same catalyst in 8×8 wells 411;
c) filling the separation columns 311 with a adsorption material;
d) introducing the carrier gas into the flow splitter 22 through the mass flow controller 21, wherein the carrier gas was distributed into 8×8 streams, directing each stream into the corresponding separation column 311;
e) simultaneously injecting the samples of 8×8 samplers 14 into the separation column 311 and heating the separation column 311 at the same temperature;
f) reacting the components desorbed out of separation columns 311 on the catalyst, collecting the retention times, reaction times and reaction intensities of the components by the signal collecting unit 5 and then transmitting these data to the signal processing unit 6;
g) analyzing the data to identify the components and contents of the samples.

What is claimed is:

1. A high-throughput analysis apparatus, comprising: sample introduction unit, flow control unit, separation unit, detection unit, signal collecting unit and signal processing unit, wherein said flow control unit comprises a flow splitter; said separation unit is directly connected to the sample introduction unit, or connected to the sample introduction through the flow control unit; said detection unit is connected to the separation unit; said signal processing unit is electrically connected to the signal collecting unit.

2. The high-throughput analysis apparatus of claim 1, wherein said detection unit comprises a reaction plate, an array of wells in the reaction plate, and at least one through hole in the bottom of each well, which penetrates the reaction plate.

3. The high-throughput analysis apparatus of claim 2, further includes a porous disk in each well.

4. The high-throughput analysis apparatus of claim 3, wherein said porous disk is made of carbon fiber paper or glass fiber paper.

5. The high-throughput analysis apparatus of claim 2, further includes a resistance wire in each well.

6. The high-throughput analysis apparatus of claim 2, wherein said reaction plate further includes at least one hole for placing heating rod.

7. The high-throughput analysis apparatus of claim 1, wherein said sample introduction unit comprises at least one multichannel valve and at least one bubbler.

8. The high-throughput analysis apparatus of claim 1, wherein said flow control unit includes at least one mass flow controller.

9. The high-throughput analysis apparatus of claim 1, wherein said separation unit comprises a separation box and a plurality of separation columns fixed in the separation box.

10. The high-throughput analysis apparatus of claim 9, wherein said separation unit further includes a temperature controlling device.

11. The high-throughput analysis apparatus of claim 10, wherein said temperature controlling device comprises a plurality of resistance wires, at least one fan blower, at least one temperature sensor and at least one temperature controller connected with the temperature sensor.

12. The high-throughput analysis apparatus of claim 9, wherein said separation columns are filled with filler.

13. The high-throughput analysis apparatus of claim 1, wherein said signal collecting unit is an infrared imaging apparatus.

14. The high-throughput analysis apparatus of claim 1, wherein said signal collecting unit is an array of thermal sensitive material.

15. A method of conducting a high-throughput analysis apparatus, comprising:
a) putting catalysts to be determined in different wells of a reaction plate;
b) introducing carrier gas into a bubbler through a mass flow controller, and then carrying out the sample in the bubbler;
c) directing the mixture of carrier gas and sample into a flow splitter, wherein the mixture flow is evenly distributed into N streams (N is a positive integer), directing each stream into a corresponding separation column in the separation box and then heating the columns under the same condition;
d) reacting the samples desorbed out of separation columns on the catalysts, collecting the reaction times and reaction intensities by a signal collecting unit and then transmitting these data to a signal processing unit;
e) analyzing the data to get the performance of the catalysts.

16. A method of conducting a high-throughput analysis apparatus, comprising:
a) putting same catalyst in different wells of a reaction plate;
b) filling at least one separation column with a kind of material whose surface area is known;
c) filling the other columns with materials to be determined;
d) introducing carrier gas into a bubbler through a mass flow controller, and then carrying out the substance in the bubbler;
e) directing the mixture of carrier gas and the substance into a flow splitter, wherein the mixture flow is evenly distributed into N streams (N a is positive integer), directing each stream into a corresponding separation column in the separation box and then heating the columns under the same condition;
f) reating the substance desorbed out of separation columns on the catalyst, collecting the reaction times and reaction intensities by a signal collecting unit and then transmitting these data to a signal processing unit;
g) comparing the peak area of the substance out from the column filled with samples with that of the substance out from the column filled with the material whose surface area is known, and calculating the surface areas of the samples.

17. A method of conducting a high-throughput analysis apparatus, comprising:
a) putting same catalyst in different wells of a reaction plate;
b) filling all columns with the same adsorption material;
c) introducing carrier gas into a flow splitter through a mass flow controller, wherein the carrier gas flow is evenly distributed into N streams (N is a positive integer), directing each stream into a corresponding separation column in the separation box through a bubbler, wherein the bubblers contain different samples, and then heating the columns under the same condition;
d) reacting the samples desorbed out of separation columns on the catalyst, collecting the retention times, reaction times and reaction intensities by a signal collecting unit then transmitting these data to a signal processing unit;
e) analyzing the data to get the components and contents of the samples.

18. A method of conducting a high-throughput analysis apparatus, comprising:
a) coating same catalyst on the resistance wire in different wells of a reaction plate;
b) filling all columns with the same adsorption material;
c) introducing carrier gas into a flow splitter through a mass flow controller, wherein the carrier gas flow is evenly distributed into N streams (N is a positive integer), directing each stream into a corresponding separation column in the separation box through a bubbler, wherein the bubblers contain different samples, and then heating the columns under the same condition;
d) reacting the components desorbed out of separation columns on the catalyst, collecting the retention times, reaction times and reaction intensities by a signal collecting unit then transmitting these data to a signal processing unit;
e) analyzing the data to get the components and contents of the samples.

19. A method of conducting a high-throughput analysis apparatus, comprising:
a) putting different samples in different samplers;
b) putting the same catalyst in different wells of a reaction plate;
c) filling all columns with the same adsorption material;
d) introducing carrier gas into a flow splitter through a mass flow controller, wherein the carrier gas flow is evenly distributed into N streams (N is a positive integer), then directing each stream into a corresponding separation column in the separation box;
e) simultaneously injecting the samples in different samplers into the corresponding separation columns, and then heating the columns under the same condition;
f) reacting the components desorbed out of separation columns on the catalyst, collecting the retention times, reaction times and reaction intensities by a signal collecting unit then transmitting these data to a signal processing unit;
g) analyzing the data to get the components and contents of the samples.

20. A method of conducting a high-throughput analysis apparatus, comprising:
a) putting different samples in different samplers;
b) coating the same catalyst on the resistance wires in different wells of a reaction plate;
c) filling all columns with the same adsorption material;
d) introducing carrier gas into a flow splitter through a mass flow controller, wherein the carrier gas flow is evenly distributed into N streams (N is a positive integer), then directing each stream into a corresponding separation column in the separation box;
e) simultaneously injecting the samples in different samplers into the corresponding separation columns, and then heating the columns under the same condition;
f) reacting the samples desorbed out of separation columns on the catalyst, collecting the retention times, reaction times and reaction intensities by a signal collecting unit then transmitting these data to a signal processing unit;
g) analyzing the data to get the components and contents of the samples.
